(19) United States
(12) Patent Application Publication
(10) Pub. No.: US 2026/0234927 A1
(43) Pub. Date: Aug. 13, 2026

(54) A MULTILAYER PROTECTION BOARD FOR CONCRETE STRUCTURES

(71) Applicant: INNOBIT INDUSTRIES LLC, UMM AL QUWAIN (AE)

(72) Inventor: ANTONY NAVEEN, UMM AL QUWAIN (AE)

(21) Appl. No.: 19/155,247

(22) PCT Filed: Feb. 10, 2023
(86) PCT No.: PCT/IB2023/051197

§ 371 Date: Aug. 10, 2025

(51) Int. Cl. E04B 1/66; C09J 7/40; E04G 9/10

(52) U.S. Cl. CPC E04B 1/665; C09J 7/405; E04G 9/10; C09J 2301/30; C09J 2301/408

(57) ABSTRACT

The invention relates to a multilayer protection board for waterproofing and/or protection of a concrete structure, wherein the concrete structure is a below ground concrete structure. The multilayer protection board comprising a base layer, and an adhesive layer laminated on a first surface of the base layer, wherein the adhesive layer adheres to poured concrete during casting of structures. A second surface of the base layer is made to attach to a waterproofing membrane of the concrete structure. The waterproofing membrane is a primary protective layer and the multilayer protection board is secondary protective layer for the waterproofing membrane and/or protection of the concrete structure. The adhesive layer optionally is surfaced with at least one filler material layer. The adhesive layer optionally comprises a releasable sheet removably attached to an outwardly facing surface of the adhesive layer, opposite a surface of the adhesive layer facing the base layer.

### FIELD OF INVENTION

The present invention relates to waterproofing and protection of concrete structures and in particular relates to a multilayer board for waterproofing and/or protection of concrete structure, including super-structure concrete and sub-structure concrete, a method of manufacturing said multilayer boards, and a waterproofing method involving said multilayer boards.

### BACKGROUND

Almost all building structures are at risk of deterioration over time due to natural factors, such as underground water seepage. Appropriate proactive action and attention to minute details right at the start of the construction, when the substructure is being made, would determine the life of the structure that is going to be constructed.

Underground water seepage is a major concern when it comes to construction industry. Water seepage from below the structure if not prevented would lead to water leaks from different parts of a building and may jeopardize the overall stability and strength of the building.

Waterproofing of sub-structures has become a critical part of any building construction nowadays. Conventional solution to said problem includes applying a waterproofing membrane to a shore wall along with loosely laid protection boards to provide waterproofing as well as puncture protection to the membrane from casting of concrete over the waterproofing membrane. The waterproofing membrane is expected to stop the migration of water through the structure. However, the process of placing reinforcement and casting concrete over the waterproofing membrane may also accidently damage the waterproofing membrane which may lead to ground water penetration into the structure. Further, even if casting is done properly without damaging the membrane, the sub-structure concrete is still prone to structural settlements, i.e., vertical displacement of a base of the structure as a result of the compression and deformation of the underlying soil, which may happen over time. Such structural settlements may damage the waterproofing membrane. Therefore, the membrane fails overtime resulting in leaks in the building.

Sheet-like waterproofing membranes are well-known for protection of substructures. The market today uses asphaltic multilayer protection board applied to protect waterprfooing (membranes) and damp proofing systems. These boards absorb the impact of aggregate shock, normal site foot traffic and protect the waterproofing membrane from penetration by the edges of reinforced steel and aggregate during the backfill process and late settlement. Although there are numerous boards such as the one discussed above, their sole purpose of use is to protect the waterproofing membrane itself.

Therefore, there is an unmet requirement in relation to waterproofing of sub-structures, which not only helps protect a waterproofing membrane used to stop ingress of water but also improve the overall waterproofing capability of structure itself.

### SUMMARY OF THE INVENTION

The present invention relates to a waterproofing and protection of concrete structure, wherein concrete structure includes super-structure concrete and sub-structure concrete, and in particular relates to a multilayer protection board for waterproofing and protection of sub-structure concrete.

One objective of the present invention is to provide better waterproofing and protection to the sub-structure concrete and super-structure concrete of the building.

Another objective of the present invention is to supplement the existing waterproofing system while eliminating the conventional limitation that leads to corrosion of the sub-structure concrete and super-structure concrete of the building.

Yet another objective of the present invention is to diminish the damage that may be caused by the structural settlements on the sub-structure concrete of the building.

To achieve the above-mentioned objectives of the present invention, in one embodiment of the present invention, there is provided a multilayer protection board comprising a base layer and an adhesive layer laminated on a first surface of the base layer. The base layer of the multilayer protection board can be made of at least one of a High-Density Polyethylene board, a polypropylene board, a modified bitumen board, a particle board, a polymer based LDPE sheet, a foam based sheet, and a polymer based sheet. The adhesive coating layer of the multilayer protection board can be made of at least one of a hot melt adhesive, a polymer modified bitumen (asphalt), a synthetic rubber, a high density polyethylene, an amorphous polyolefin (APO) ground Vulcanized crumb rubber, a plasticizer and a combination thereof.

The base layer is made to attach to a waterproofing membrane of a concrete structure. Said attachment can be achieved using spot bonding the base layer of the multilayer protection board to the waterproofing membrane. Once the multilayer protection board is fixed, formwork is done and concrete is casted on the adhesive coating layer of the multilayer protection board, such that the adhesive coating layer adheres to a surface of a fresh concrete poured laid during the formwork. The waterproofing membrane acts as a primary protective layer and the multilayer protection board acts as a secondary protective layer for waterproofing and/or protection of a concrete structure.

According to the present invention, fixing the base layer on the waterproofing membrane protects the waterproofing membrane and the concrete structure from dampness and water penetration from the ground. Further, adhesion of the multilayer protection board to the concrete structure also averts any leaks or damage by preventing any lateral migration of the water to the concrete structure. Therefore, unlike conventional protection boards which only protect waterproofing membrane, the multilayer protection board of the present invention efficiently avoids concrete damage and water infiltration to the concrete structure by protecting not only the waterproofing membrane but in itself acts as the secondary waterproofing protection to the cast concrete and prevents any water infiltration or concrete deterioration. Furthermore, it offers permanent protection to most waterproofing and damp proofing systems, such as to a bitumen based waterproofing sheet membrane.

A surface of the adhesive coating layer of the multilayer protection board may optionally be protected by a protective layer. In one embodiment of the present invention, said protective layer may be a layer of filler material comprising granules of sand or other similar fillers. In another embodiment of the present invention said protective layer may be a releasable sheet that is removably attached to an outwardly facing surface of the adhesive layer, which is opposite a surface of the adhesive layer facing the base. Said releasable sheet may be a silicon release sheet.

According to the present invention, adding a protective layer over the adhesive coating layer, by using either the layer of sand granules filler material or the removable silicon release sheet, ensures that the adhesive coating layer is not damaged in subsequent construction activities. Further, it protects the multilayer protection board while it is being transported or while it is being stored in the inventory.

In one embodiment of the present invention, the thickness of the multilayer protection board ranges from 2 mm to 20 mm, wherein a thickness of the base layer of the multilayer protection board ranges from 1 mm to 17 mm, and a thickness of the adhesive coating layer of the multilayer protection board ranges from 1 mm to 3 mm.

In one embodiment of the present invention, the size of the multilayer protection board usually ranges from 2 meter to 3 meter in length and 0.5 meter to 1.5 meter in width.

In another embodiment of the invention, concrete structure is a below grade concrete structure, such as a concrete sub-structure.

In yet another embodiment of the invention, concrete structure is an above ground concrete structure, such as a concrete super-structure.

In a preferred embodiment of the present invention, the fixing comprises placing a plurality of multilayer protection boards closely together as butt joint, and sealing the boards with a tape. The tape may include a combination of polyethylene sheets and may also include the same material as the adhesive layer.

According to the present invention, even if the multilayer protection board gets compromised, still the damage done on the sub-structure concrete of the building is minimized due to adhesion of the multilayer protection board to the cast concrete. Conventionally, a compromised protection board leads to leakage of water which spreads all across the structure. However, with the multilayer protection board of the present invention, the water leak will only be localized to a particular point on a single concerned multilayer protection board as each multilayer protection board adheres to the cast concrete. Thus, damage can be easily treated with a process of injection. Said process of injection is usually carried out in walls and floors to stop water leaks where a resin material is inserted to stop the water leaks. Further, structural settlement may fail the conventional waterproofing layer and the conventional waterproofing system. However, the multilayer protection board of the present invention shields the sub-structure concrete from the effects of the structural settlement by acting as a second layer that adheres to cast concrete and chances of any water leaks through the structure is minimized.

Another objective of the present invention is to propose a method of manufacturing a multilayer protection board of the present invention for waterproofing and protection of concrete structure, wherein concrete structure includes super-structure concrete and sub-structure concrete.

Another objective of the present invention is to present a method of manufacturing a multilayer protection board that is capable of supplementing the existing waterproofing system while eliminating the conventional limitation that leads to corrosion of the concrete structure of the building.

Yet another objective of the present invention is to present a method of manufacturing a multilayer protection board that is capable of diminishing the damage that may be caused by the structural settlements on the sub-structure concrete of the building.

To accomplish the above-mentioned objectives, the present invention presents a method of manufacturing a multilayer protection board for waterproofing and protection of concrete structures. The method of manufacturing the multilayer protection board includes forming a base layer by an extrusion process, where the base layer has a first surface and a second surface. The base layer is run in a coating line, where an adhesive coating layer is laminated over the first surface of the base layer. The base layer of the multilayer protection board includes of at least one of a High-Density Polyethylene board, a polypropylene board, a modified bitumen board, a particle board, a polymer based LDPE sheet, a foam based sheet and a polymer based sheet. The adhesive coating layer of the multilayer protection board includes of at least one of a hot melt adhesive, a polymer modified bitumen, and a combination thereof. Here, a second surface of the base layer which is attachable to a waterproofing membrane of a concrete structure.

According to the present invention, the multilayer protection board manufactured using said method may be implemented as an additional layer of protection and waterproofing of a concrete structure to avert any leaks or damage by preventing any lateral migration of the water to the concrete structure. Further, the adhesive layer of the multilayer protection board adheres to the concrete layer, thus, unlike conventional loosely laid protection boards, avoiding concrete damage and water infiltration to the concrete structure by acting as as a secondary waterproofing to the case concrete. Furthermore, it offers permanent protection to most waterproofing and damp proofing systems. Preventing lateral migration means that incase of any water infiltration, the leak will be localized and hence the repair is much more easier and cheaper.

In another aspect of the present invention, the method further includes optionally applying a filler layer to an outwardly facing surface of the adhesive layer of the multilayer protection board, opposite to a surface of the adhesive layer facing the base layer. For adding the filler layer over the outwardly facing surface of the adhesive layer, the multilayer protection board is run through a duster where chemically treated granules are spread. The filler material comprising of at least one of a sand granules or any other filler material.

In another aspect of the present invention, the method further includes optionally attaching a releasable sheet to an outwardly facing surface of the adhesive layer of the multilayer protection board, opposite to a surface of the adhesive layer facing the base layer.

According to the present invention, adding a protective layer over the adhesive coating layer as a covering, by using either the layer of sand granules filler material or the removable silicon release sheet, during the manufacturing the multilayer protection board ensures that the tacky surface of the adhesive coating layer remains intact and is not damaged in subsequent construction activities. It also protects the multilayer protection board while it is being transported or while it is being stored in the inventory.

In another aspect of the present invention, the multilayer protection boards are passed through a cutter which cuts it to the designated sizes, where thicknesses are maintained at the time of lamination and accordingly adjustments are made. The thickness of the multilayer protection board formed during manufacturing ranges from 2 mm to 20 mm, wherein the thickness of the base layer of the multilayer protection board formed during manufacturing ranges from 1 mm to 17 mm, and the thickness of the adhesive layer of the multilayer protection board formed during manufacturing ranges from 1 mm to 3 mm.

In another aspect of the present invention, the size of the manufactured multilayer protection board usually ranges from 2 meter to 3 meter in length and 0.5 meter to 1.5 meter in width.

Yet another objective of the present invention is to present a method of waterproofing and protecting a concrete structure using multilayer protection boards wherein concrete structure includes super-structure concrete and sub-structure concrete.

Another objective of the present invention is to present a method of waterproofing and protecting a concrete structure using a multilayer protection board that is capable of supplementing the existing waterproofing system while eliminating the conventional limitation that leads to corrosion of the cast concrete of the building.

Yet another objective of the present invention is to present a method of waterproofing and protecting a sub-structure concrete using a multilayer protection board that is capable of diminishing the damage that may be caused by the structural settlements on the cast concrete of the building.

To accomplish the above mentioned objective, in one aspect of the present invention is presented a method of waterproofing and protecting a concrete structure using multilayer protection boards.

The method includes applying a layer of a waterproofing material on a concrete structure to form a waterproofing membrane. Said waterproofing membrane acts as a primary layer of waterproofing and protection of the sub-structure concrete. The method further includes spot bonding one or more multilayer protection boards of the present invention to said waterproofing membrane, wherein the one or more multilayer protection boards includes a base layer and an adhesive coating layer laminated on a first surface of the base layer opposite to the second surface of the base layer that faces the waterproofing membrane. The method further includes casting a concrete structure in contact with a surface of the multilayer protection board having the adhesive coating layer. The adhesion of the multilayer protection board to the cast concrete averts any leaks or damage by preventing any lateral migration of the water to the concrete structure. Further, said multilayer protection board adds to the strengthening of the sub-structure concrete and also acts as a secondary layer of waterproofing and protection of the cast concrete.

In another aspect of the present invention, the method further includes sealing edges of the multilayer protection boards, prior casting the concrete structure, by a tape. The tape includes polyethylene sheets or the same material as the adhesive layer.

In yet another aspect of the present invention, where the multilayer protection board according to the present invention includes an optional releasable sheet, removably attached on an outwardly facing surface of the adhesive coating layer, then removing a releasable sheet prior to formwork and casting the concrete structure.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a side view showing different layers of the multilayer protection board according to one or more embodiments of the present invention.

FIG. 2 illustrates a perspective view of the multilayer protection board comprising a layer of a filler material according to one or more embodiments of the present invention.

FIG. 3 illustrates a perspective view of the multilayer protection board comprising a layer of releasable sheet according to one or more embodiments of the present invention.

FIG. 4 illustrates a sectional view of a sub-structure concrete including the multilayer protection board according to one or more embodiments of the present invention.

### DETAILED DESCRIPTION OF THE INVENTION

As required, detailed embodiments of the present invention are disclosed herein, however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

A typical building structure includes two major components: a sub-structure and a super-structure above the sub-structure. The part of the building structure underneath the ground level is known as the sub-structure and the part of the building above the ground level is called the super-structure. The sub-structure plays a critical role in safely transferring the load of the super-structure of the building to the soil underneath. If the sub-structure gets weakened due to any factor, then all supported structure above may collapse, causing a disaster.

Sub-structures are generally made of reinforced concrete. To avoid seepage of water from below, a waterproofing membrane is applied on the surface of the shore wall which is built prior to casting of substructure. These membranes are protected using support boards prior to the placement of reinforcement/formwork and casting of concrete above the sub-structure till it reaches the plinth level of the building. Though the waterproofing membrane, along with other support boards to provide puncture protection, is supposed to provide waterproofing, in most cases the arrangement fails to do so which ultimately leads to leaks in the building.

The present invention aims to ameliorate the existing protection and/or waterproofing solution used in concrete structures.

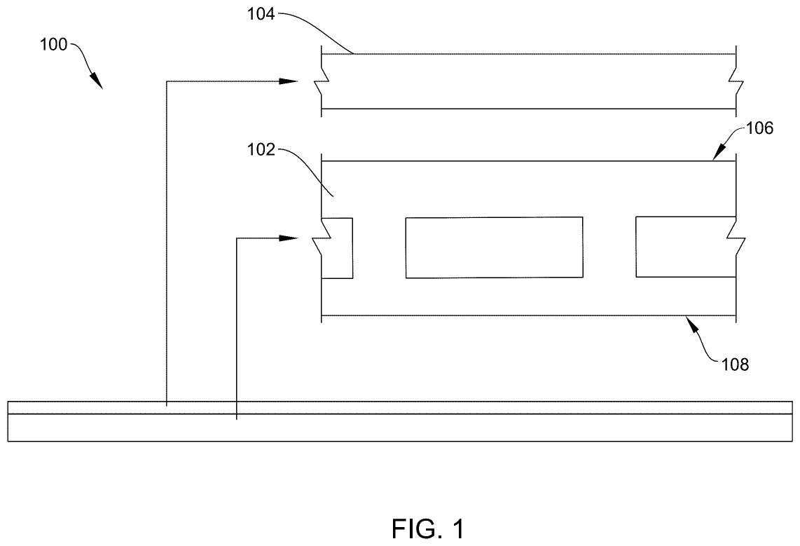

FIG. 1 illustrates a multilayer protection board (100) for waterproofing and protection of a sub-structure concrete, in accordance with an aspect of the present invention. The multilayer protection board (100), in an embodiment, includes a base layer (102) and an adhesive layer (104) laminated on a first surface (106) of the base layer (102). The adhesive layer (104) is provided to adhere to a surface of fresh concrete poured during construction activity. The base layer (102) may be made of at least one of High-Density Polyethylene, polypropylene, modified bitumen, particle material (chip or waste) board or a polymer based LDPE material, foam based material, and a polymer based sheets. The adhesive coating layer (104) may be made of a material comprising at least one of a hot melt adhesive, polymer modified bitumen, and a combination thereof.

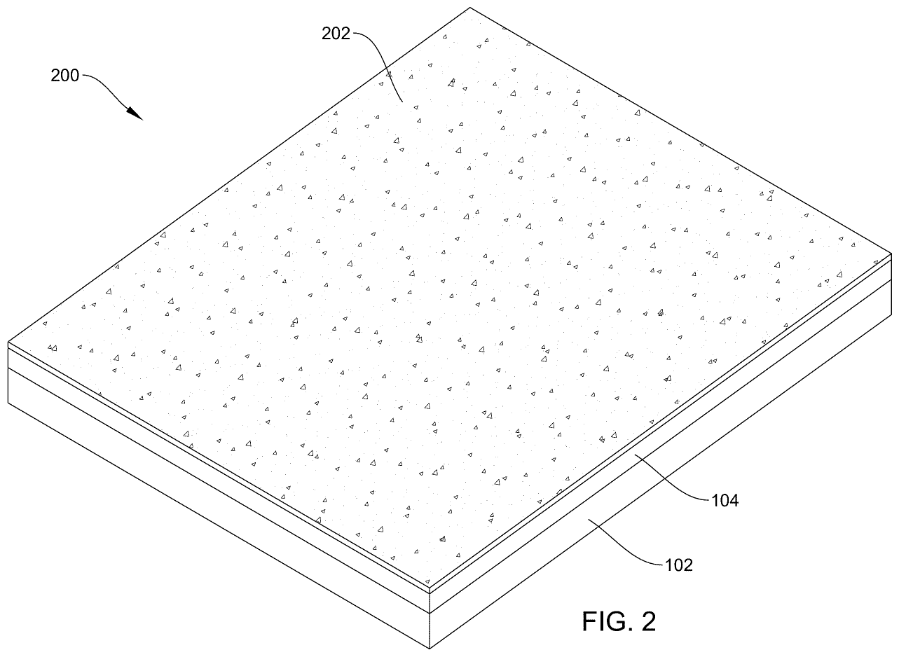

Referring to FIG. 2, in a preferred embodiment of the present invention, the multilayer protection board (200) includes an optional filler material layer (202) attached to an outwardly facing surface of the adhesive layer (104), opposite a surface of the adhesive layer facing the base layer (102). The filler material layer (202) ensures that the adhesive coating layer (104) is not damaged in subsequent construction activities. The filler material also protects the adhesive coating layer (104) while the boards (100) are being transported to the construction site or stored in a warehouse. The filler material (202) may include sand or any other similar material.

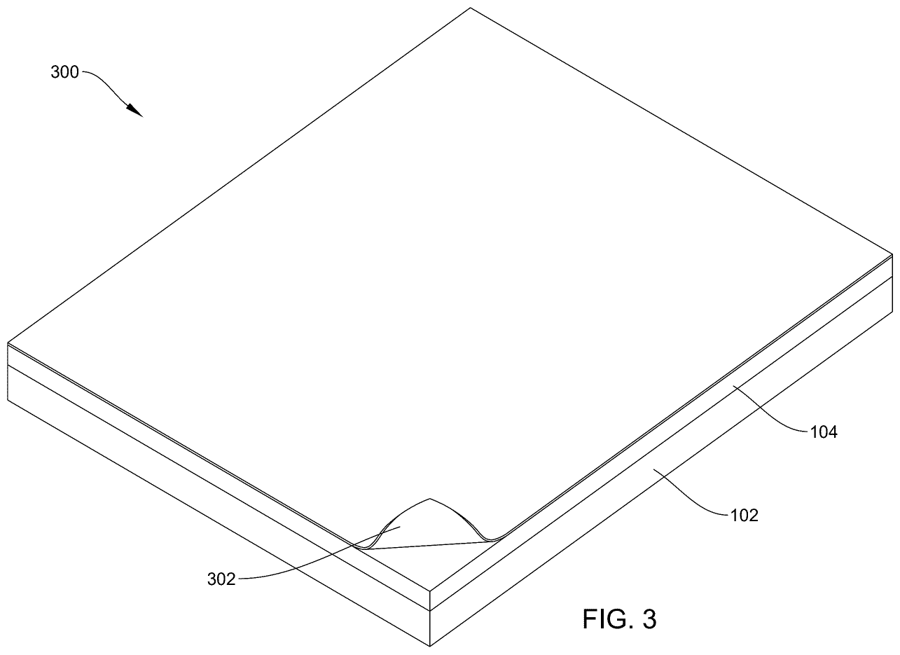

Referring to FIG. 3, in another preferred embodiment of the present invention, the multilayer protection board (300) includes, optionally, a layer of a releasable sheet (302) removably attached to an outwardly facing surface of the adhesive coating layer (104), opposite a surface of the adhesive coating layer facing the base layer (102). The releasable sheet (302) ensures that the adhesive coating layer (104) is not damaged in subsequent construction activities. In an embodiment, the releasable sheet (302) is made of silicon coated polymer or paper film.

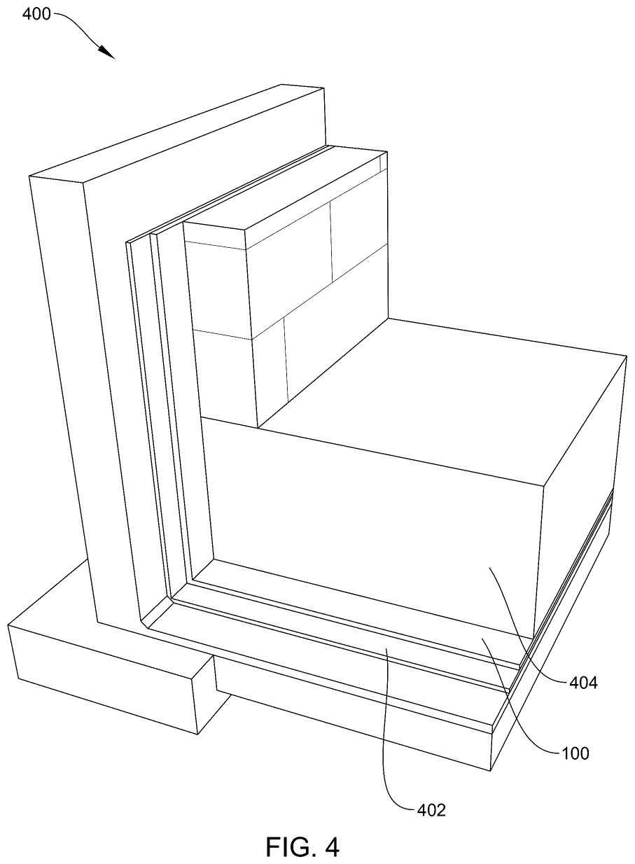

FIG. 4 illustrates a sectional view of a sub-structure concrete (400). During implementation of the multilayer protection boards (100) at a construction site, first the shore-wall is fixed with a waterproof membrane (402), which acts as the primary protection against water leaks. Further, the multilayer protection boards (100) of the present invention are then spot bonded to the waterproofing membrane (402). In an implementation, the boards (100) are placed closely as butt joint to cover all of the waterproof membrane (402). Once the plurality of multilayer protection boards (100) are affixed to the waterproofing membrane (402), their edges are sealed with tape (not shown in the figure). The tape material can be a combination of polyethylene sheets and may also include the same material as the adhesive layer (104). After sealing of the edges of the butt joined protection boards (100), reinforcement/formwork is placed on top of the protection boards (100) and/or a concrete slab/wall (404) is cast, on the adhesive layer (104) side of the multilayer protection boards (100).

Although the above embodiment disclosed application of the multilayer protection boards (100) in the sub-structure or below-ground concrete, however, said multilayer protection boards (100) can also be applied, in similar manner, for super-structure concrete or above ground as well.

According to the present invention, fixing the base layer on the waterproofing membrane protects the waterproofing membrane and the sub-structure concrete and super-structure concrete from dampness and water penetration from the ground. Further, adhesion of the multilayer protection board to the concrete structure also averts any leaks or damage by preventing any lateral migration of the water to the concrete structure. Therefore, the multilayer protection board of the present invention efficiently avoids concrete damage and water infiltration to the concrete structure by protecting not only the waterproofing membrane but in itself acts as a secondary waterproofing protection to the cast concrete and helps prevents any water infiltration or concrete deterioration. Furthermore, it offers permanent protection to most waterproofing and damp proofing systems, such as to a bitumen based waterproofing sheet membrane.

Further, even if the multilayer protection board gets compromised, still the damage done on the sub-structure concrete of the building is minimized as the water leak will only be localized to a particular point on a single concerned multilayer protection board as each multilayer protection board adheres to the cast concrete. Such a damage can be easily treated through localized resin injection to stop the leaks.

Further, the multilayer protection board as disclosed herein provides protection against any structural settlement.

Example composition:
Base layer: Corrugated High-Density Polyethylene [HDPE] board thickness 5 mm. Standard size 1 m×2 m.
Adhesive Layer: Polymer modified bitumen adhesive with thickness 2 mm.

Test details:
puncture resistance>>>200 lbs (600 N)>>>ASTM E154
adhesion to concrete>>>5 lbs/in. (880 N/m)>>>ASTM D903
restricts lateral migration of water>>>Pass at 231 ft (71 m) of hydrostatic head pressure>>>ASTM D5385
water resistance>>>231 ft (71 m)>>>ASTM D5385
water vapor permeance>>><0.01 perms (0.6 ng/(Pa×s×m2)>>>ASTM E96, method B

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall there between.

1. A multilayer protection board for waterproofing and/or protection of a concrete structure, the multilayer protection board comprising:
a base layer; and
an adhesive coating layer laminated on a first surface of the base layer, wherein the adhesive layer adheres to poured concrete during casting of structures.

2. The multilayer protection board according to claim 1, wherein a second surface of the base layer is made to attach to a waterproofing membrane of the concrete structure.

3. The multilayer protection board according to claim 2, wherein the waterproofing membrane is a primary protective layer and the multilayer protection board is secondary protective layer for the waterproofing membrane and/or protection of the concrete structure.

4. The multilayer protection board according to claim 1, wherein the base layer comprises at least one of a High-Density Polyethylene board, a polypropylene board, a modified bitumen board, a particle board, a polymer-based LDPE sheet, a foam based sheet, and a polymer based sheet.

5. The multilayer protection board according to claim 1, wherein the adhesive coating layer comprises at least one of a hot melt adhesive, polymer modified bitumen, and a combination thereof.

6. The multilayer protection board according to claim 1, wherein the adhesive layer optionally is surfaced with at least one filler material layer.

7. The multilayer protection board according to claim 6, wherein the filler material layer comprises sand granules or any particle fillers.

8. The multilayer protection board according to claim 1, wherein the adhesive layer optionally comprises a releasable sheet removably attached to an outwardly facing surface of the adhesive layer, opposite a surface of the adhesive layer facing the base layer.

9. The multilayer protection board according to claim 8, wherein the releasable sheet comprises a silicon release sheet/paper/film 10. The multilayer protection board according to claim 1, wherein:
a thickness of the base layer ranges from 1 mm to 17 mm;
a thickness of the adhesive coating layer ranges from 1 mm to 3 mm; and
a thickness of the multilayer protection board ranges from 2 mm to 20 mm.

11. The multilayer protection board according to claim 1, wherein the concrete structure is a below ground concrete structure.

12. The multilayer protection board according to claim 1, wherein edges of multilayer protection boards are placed closely as butt joint and sealed with a tape.

13. A method of manufacturing a multilayer protection board for waterproofing and protection of concrete structure, the method comprising:
forming a base layer by an extrusion process; and
running the base layer in a coating line for laminating an adhesive coating layer on a first surface of the base layer, wherein a second surface of the base layer is attachable to a waterproofing membrane of a concrete structure.

14. The method of manufacturing a multilayer protection board according to claim 13, wherein thickness of the multilayer protection board is maintained and adjusted during the lamination process.

15. The method of manufacturing a multilayer protection board according to claim 13, wherein a material of the base layer is selected from at least one of a High-Density Polyethylene board, a polypropylene board, a modified bitumen board, a particle board, a polymer based LDPE sheet, a foam based sheet and a polymer based sheet.

16. The method of manufacturing a multilayer protection board according to claim 13, wherein a material of the adhesive layer is selected from at least one of a hot melt adhesive, a polymer modified bitumen, and a combination thereof.

17. The method of manufacturing a multilayer protection board according to claim 13, further comprising running the multilayer protection board through a duster, wherein chemically treated granules are spread over the surface of the adhesive layer, applying a layer of a filler material with at least one filler material comprising sand granules.

18. The method of manufacturing a multilayer protection board according to claim 13, optionally comprising attaching a releasable sheet to an outwardly facing surface of the adhesive layer, opposite to a surface of the adhesive layer facing the base layer.

19. The method of manufacturing a multilayer protection board according to claim 13, further comprising passing the multilayer protection board through a cutter for cutting the multilayer protection board to a designated size, wherein thickness and adjustments are maintained during the lamination with adhesive coating layer.

20. A method of waterproofing and protecting a concrete structure using multilayer protection boards, the method comprising:
applying a layer of a waterproofing material on a concrete structure to form a waterproofing membrane;
spot bonding or nailed to one or more multilayer protection boards to said waterproofing membrane, wherein each of said one or more multilayer protection boards comprising:
a base layer; and
an adhesive coating layer laminated on a first surface of the base layer opposite the second surface of the base layer that faces said waterproofing membrane; and
casting a concrete structure in contact with a surface of the multilayer protection board having the adhesive coating layer.

21. The method according to claim 20, further comprises sealing edges of multilayer protection boards placed closely as butt joint by a tape.

22. The method according to claim 20, further comprising removing a releasable sheet, removably attached on an outwardly facing surface of the adhesive layer prior to casting the concrete structure.
